(19) United States
(12) Patent Application Publication
(10) Pub. No.: US 2025/0148485 A1
(43) Pub. Date: May 8, 2025

(54) PURCHASE ANALYSIS APPARATUS, PURCHASE ANALYSIS METHOD, AND NON-TRANSITORY COMPUTER-READABLE MEDIUM

(71) Applicant: NEC Corporation, Minato-ku, Tokyo (JP)

(72) Inventors: Noboru YOSHIDA, Tokyo (JP); Ryo KAWAI, Tokyo (JP); Jamquan LIU, Tokyo (JP)

(73) Assignee: NEC Corporation, Minato-ku, Tokyo (JP)

(21) Appl. No.: 18/730,106

(22) PCT Filed: Feb. 2, 2022
(86) PCT No.: PCT/JP2022/004100

§ 371 Date: Jul. 18, 2024

(51) Int. Cl. G06Q 30/0201; G06V 20/40; G06V 20/52; G06V 40/20

(52) U.S. Cl. CPC G06Q 30/0201; G06V 20/40; G06V 20/52; G06V 40/20

(57) ABSTRACT

There are provided a purchase analysis apparatus and method, and the like for analyzing in detail behavior of a customer related to a product or the like. A purchase analysis apparatus includes an action specification unit that analyzes an action of the customer in a sales room included in the captured video data and specifies the action of the customer according to a stored action pattern, a product-related information specification unit that specifies product-related information in which the customer is interested, based on the specified action of the customer or a position of the customer, and an association unit that associates the specified action with the product-related information.

### TECHNICAL FIELD

The present disclosure relates to a purchase analysis apparatus, a purchase analysis method, and a non-transitory computer-readable medium.

### BACKGROUND ART

Techniques for analyzing behavior of customers in a retail store by using a point of sale (POS) have been developed.

For example, Patent Literature 1 discloses a behavior analysis apparatus that analyzes behavior of a customer in a store, the behavior analysis apparatus including a posture estimation unit that estimates a posture of the customer in the store on the basis of an image obtained by capturing an image of the inside of the store and acquires posture information, a product variation information extraction unit that analyzes a display state of a product in the store and extracts product variation information indicating a variation in the display state from the image, and a purchase behavior determination unit that determines purchase behavior of the customer on the basis of the posture information and the product variation information.

### CITATION LIST

### Patent Literature

Patent Literature 1: Japanese Unexamined Patent Application Publication No. 2019-211891

### SUMMARY OF INVENTION

### Technical Problem

However, the behavior of the customer related to the product or the like, such as the behavior of the customer related to the product that has not been purchased, cannot be analyzed in detail.

In view of the above-described problems, an object of the present disclosure is to provide a purchase analysis apparatus that analyzes behavior of a customer related to a product or the like in a sales room in more detail, a purchase analysis method, and a non-transitory computer-readable medium.

### Solution to Problem

A purchase analysis apparatus according to an aspect of the present disclosure includes
an action specification means for analyzing an action of a customer in a sales room included in captured video data and specifying the action of the customer according to a stored action pattern,
a product-related information specification means for specifying product-related information in which the customer is interested, based on the specified action of the customer or a position of the customer, and
an association means for associating the specified action with the product-related information.

A purchase analysis method according to an aspect of the present disclosure includes
analyzing an action of a customer in a sales room included in captured video data and specifying the action of the customer according to a stored action pattern,
specifying product-related information in which the customer is interested, based on the specified action of the customer or a position of the customer, and
associating the specified action with the product-related information.

A non-transitory computer-readable medium according to an aspect of the present disclosure stores a program for causing a computer to execute a purchase analysis method, the purchase analysis method including
analyzing an action of a customer in a sales room included in captured video data and specifying the action of the customer according to a stored action pattern,
specifying product-related information in which the customer is interested, based on the specified action of the customer or a position of the customer, and
associating the specified action with the product-related information.

### Advantageous Effects of Invention

According to the present disclosure, it is possible to provide a purchase analysis apparatus that analyzes behavior of a customer related to a product or the like in detail, a purchase analysis method, and a non-transitory computer-readable medium.

### BRIEF DESCRIPTION OF DRAWINGS

FIG. 1 is a block diagram illustrating a configuration of a purchase analysis apparatus according to a first example embodiment.

FIG. 2 is a flowchart illustrating a flow of a purchase analysis method according to the first example embodiment.

FIG. 3 is a block diagram illustrating a configuration of a purchase analysis apparatus according to a second example embodiment.

FIG. 4 is a flowchart illustrating a flow of a purchase analysis method according to the second example embodiment.

FIG. 5 is a block diagram illustrating a configuration of a purchase analysis apparatus according to a third example embodiment.

FIG. 6 is a flowchart illustrating a flow of a purchase analysis method according to the third example embodiment.

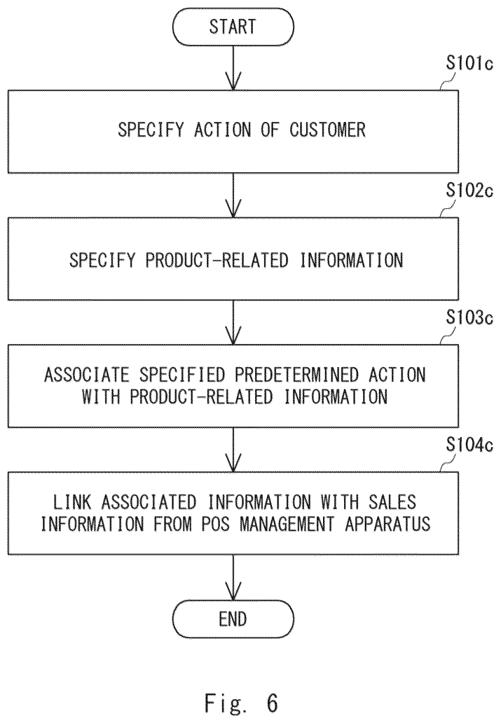

FIG. 7 is a diagram illustrating an overall configuration of a purchase analysis apparatus according to a fourth example embodiment.

FIG. 8 is a block diagram illustrating detailed configurations of a purchase analysis apparatus 100 and a POS management apparatus 200 according to the fourth example embodiment.

FIG. 9 is a diagram illustrating skeleton information of a customer extracted from a frame image included in video data according to the fourth example embodiment.

FIG. 10 is an enlarged view of a hand of the customer included in the frame image according to the fourth example embodiment.

FIG. 11 is an enlarged view of the hand of the customer included in the frame image according to the fourth example embodiment.

FIG. 12 is a diagram illustrating the frame image included in the video data according to the fourth example embodiment.

FIG. 13 is a flowchart illustrating a flow of a method of registering a registration action ID and a registration action sequence by a server according to the fourth example embodiment.

FIG. 14 is a diagram for explaining various registration actions according to the fourth example embodiment.

FIG. 15 is a diagram for explaining an action sequence having a high purchase probability according to the fourth example embodiment.

FIG. 16 is a diagram for explaining a sequence having a low purchase probability according to the fourth example embodiment.

FIG. 17 is a flowchart illustrating a flow of a purchase analysis method by the purchase analysis apparatus 100 according to the fourth example embodiment.

FIG. 18 is a block diagram illustrating a configuration of an imaging apparatus according to a fifth example embodiment.

FIG. 19 is a block diagram illustrating a hardware configuration of the purchase analysis apparatus.

### EXAMPLE EMBODIMENT

Hereinafter, the present disclosure will be described through example embodiments, but the disclosure according to the claims is not limited to the following example embodiments. In addition, not all the configurations described in the example embodiment are essential as means for solving the problem. In the drawings, the same elements are denoted by the same reference numerals, and repeated description is omitted as necessary.

### First Example Embodiment

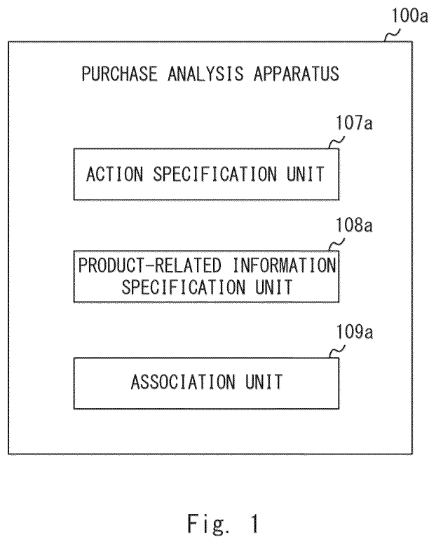

FIG. 1 is a block diagram illustrating a configuration of a purchase analysis apparatus 100a according to a first example embodiment. The purchase analysis apparatus 100a can be realized by a computer server or the like including a processor and a memory. The purchase analysis apparatus 100a can be used to analyze and specify an action of a customer in video data, and to provide analysis information obtained by associating the action with information of a product or the like (also referred to as product-related information). Specifically, the purchase analysis apparatus 100a includes an action specification unit 107a that analyzes an action of the customer in a sales room included in the captured video data and specifies the action of the customer according to a stored action pattern, a product-related information specification unit 108a that specifies product-related information in which the customer is interested, based on the specified action of the customer or a position of the customer, and an association unit 109a that associates the specified action with the product-related information.

The action specification unit 107a can specify a characteristic purchase action of the customer from the video data captured in various sales rooms such as supermarkets, home centers, and convenience stores. The characteristic purchase action may be various actions such as picking up a product, returning a product to a product shelf, and comparing products in front of the product shelf. The customer actions that can be specified may be one or more customer actions, or may be a series of continuous customer actions.

The product-related information in which the customer is likely to be interested is information associated with a product or the like in which the customer is interested, and can include, for example, at least one or all of a product (for example, a product number, a product name, and the like), a product classification (for example, chocolate, confectionery, beverage, and the like), a product shelf, and floor map information associated with these pieces of information. Note that the floor map information is also referred to as a floor guide, and can be information for a customer to find where in a sales room various products are.

The product-related information specification unit 108a can specify the product-related information in which the customer is likely to be interested by comprehensively determining a position where the customer is standing and an action of the customer. For example, when the customer picks up a product, it can be determined that there is a high possibility that the customer is interested in the product. In addition, when the customer stands in front of a product shelf and directs gaze or faces toward a specific product for a predetermined time or more, it can be determined that there is a high possibility that the customer is interested in the specific product. In some example embodiments, the product-related information specification unit 108a may specify a product, a product shelf, or the like closest to a position of the customer who has performed the specified action in terms of distance as the product-related information.

The association unit 109a can associate the product-related information with the action specified in various form. The various forms may be any forms in which an analyst can recognize association between the specified action and the product-related information. For example, the association may be association between a moving image or an image and code indicating the product-related information, or may be association in a form of a table between description (type) of the action and code indicating the product-related information.

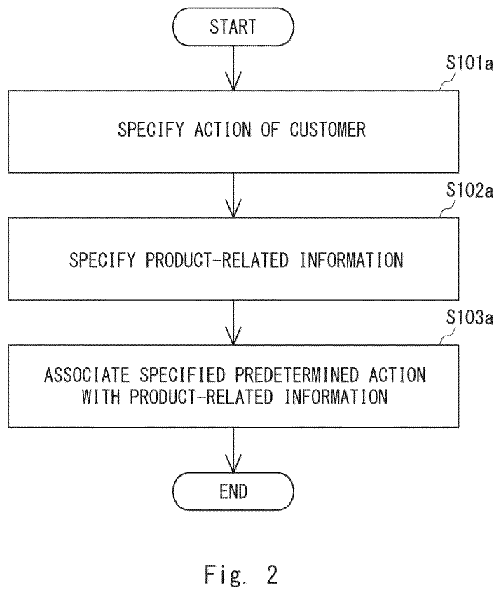

FIG. 2 is a flowchart illustrating a flow of a purchase analysis method according to the first example embodiment.

The purchase analysis method according to the first example embodiment includes the following processes. The action specification unit 107a analyzes the action of the customer in the sales room included in the captured video data, and specifies the action of the customer according to the stored action pattern (step S101a). The product-related information specification unit 108a specifies the product-related information in which the customer is interested, based on the specified action of the customer or position of the customer (step S102a). The association unit 109a associates the specified predetermined action with the product-related information (step S103a).

According to the first example embodiment described above, it is possible to provide information for analyzing behavior of a customer related to a product or the like in detail.

### Second Example Embodiment

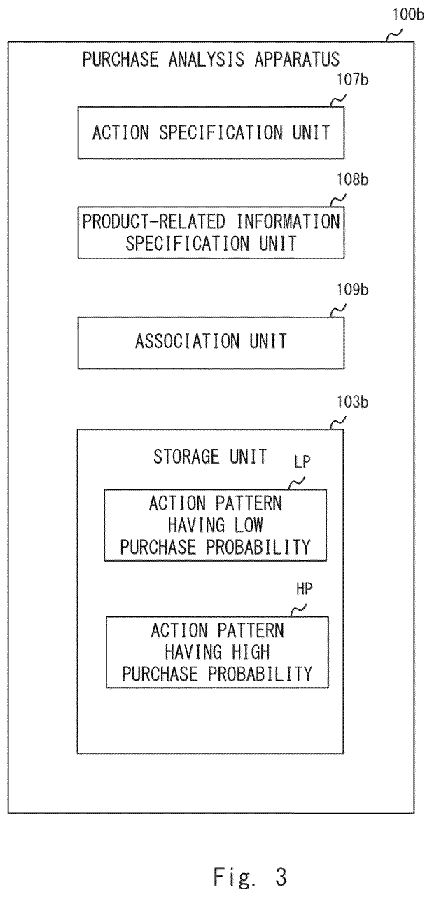

FIG. 3 is a block diagram illustrating a configuration of a purchase analysis apparatus 100b according to a second example embodiment. A basic configuration of the purchase analysis apparatus 100b according to the present second example embodiment is similar to that of the first example embodiment, and a detailed description thereof will be omitted. A storage unit 103b of the purchase analysis apparatus 100b according to the second example embodiment stores an action pattern LP having a relatively low purchase probability and an action pattern HP having a high purchase probability. The action specification unit 107b according to the second example embodiment can specify the action of the customer according to the action pattern LP having the relatively low purchase probability and the action pattern HP having the high purchase probability. The association unit 109b according to the second example embodiment can associate some pieces of product-related information with an action of the customer having a high purchase probability, and can associate some other pieces of product-related information with an action of the customer having a low purchase probability.

In some other example embodiments, the storage unit 103b stores at least the action pattern LP having the relatively low purchase probability. The action specification unit 107b specifies an action of the customer having a relatively low purchase probability based on the stored action pattern having the relatively low purchase probability. The association unit 109b associates an action of a specific customer having a relatively low purchase probability with the specified product-related information.

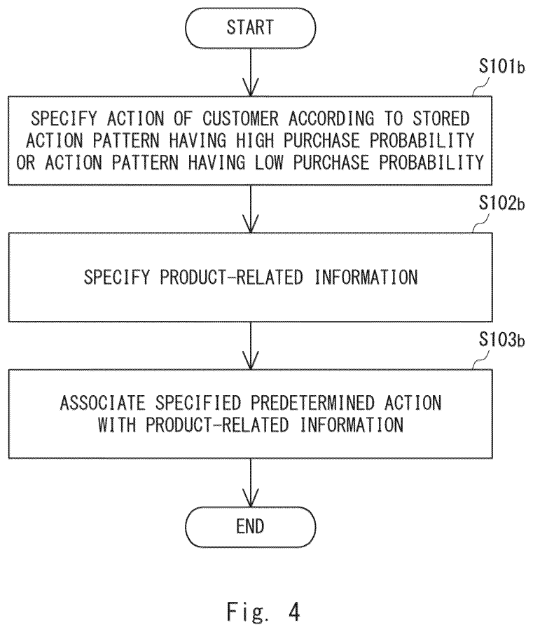

FIG. 4 is a flowchart illustrating a flow of a purchase analysis method according to the second example embodiment.

The purchase analysis method according to the second example embodiment includes the following processes. The action specification unit 107b analyzes the action of the customer in the sales room included in the captured video data, and specifies the action of the customer according to the stored action pattern having the relatively high purchase probability and action pattern having the relatively low purchase probability (step S101b). The product-related information specification unit 108b specifies the product-related information in which the customer is interested, based on the specified action of the customer or position of the customer (step S102b). The association unit 109b associates the specified action of the customer with the product-related information (step S103b).

In some example embodiments, the action specification unit 107b may specify an action of the customer having a relatively low purchase probability based on the stored action pattern having the relatively low purchase probability. The association unit 109b may associate the specified action having the relatively low purchase probability with product-related information corresponding to the specified action.

As a result, related information indicating a purchase probability related to product-related information can be obtained, and as a result, detailed purchase analysis can be performed. Specifically, it is possible to perform classification into a product associated with an action having a relatively high purchase probability and a product associated with an action having a relatively low purchase probability. In particular, with respect to product-related information, such as a product or a product classification that has not been purchased or is not likely to be purchased, not obtained by the POS system so far, it is possible to obtain information indicating whether or not the customer is interested, and to perform more detailed purchase analysis.

### Third Example Embodiment

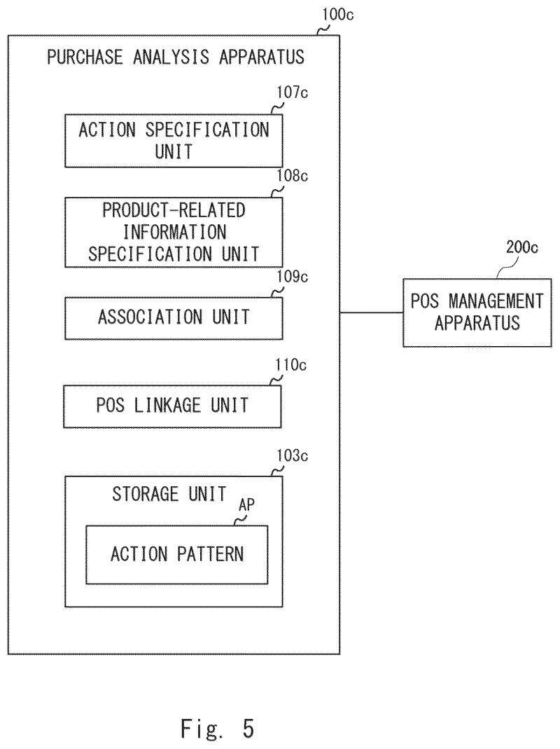

FIG. 5 is a block diagram illustrating a configuration of a purchase analysis apparatus 100c according to a third example embodiment. The purchase analysis apparatus 100c can be used to analyze and specify an action of a customer in video data, and to provide information obtained by associating the action, information of a product or the like (also referred to as product-related information), and sales information thereof. Specifically, the purchase analysis apparatus 100c includes an action specification unit 107c that analyzes an action of the customer in a sales room included in the captured video data and specifies the action of the customer according to a stored action pattern, a product-related information specification unit 108c that specifies product-related information in which the customer is interested based on the specified action of the customer or a position of the customer, an association unit 109c that associates the specified action with the product-related information, and a POS linkage unit 110c that acquires sales information of a product or product-related information specified based on the specified action from a POS management apparatus 200. The POS linkage unit 110c cooperates with a POS terminal device and the POS management apparatus 200c to support the above-described association of the association unit 109c. The storage unit 103c stores action patterns of various customers.

FIG. 5 is a flowchart illustrating a flow of a purchase analysis method according to the third example embodiment.

The purchase analysis method according to the third example embodiment includes the following processes. The action specification unit 107c analyzes the action of the customer in the sales room included in the captured video data, and specifies the action of the customer according to stored various action patterns (step S101c). The product-related information specification unit 108c specifies the product-related information in which the customer is interested, based on the specified action of the customer or position of the customer (step S102c). The association unit 109c associates the specified predetermined action with the product-related information (step S103c). The associated information is linked with the sales information from the POS management apparatus (step S104c).

The POS linkage unit 110c can recognize the predetermined action specified by the action specification unit 107c and whether or not the predetermined product specified by the product-related information specification unit 108c has actually been purchased. Therefore, in cooperation with the POS linkage unit 110c, the association unit 109c can obtain information indicating whether or not the customer is interested in a product that has not been purchased or what kind of purchase action the customer is performing for the product, and can perform more detailed purchase analysis.

### Fourth Example Embodiment

Next, a fourth example embodiment of the present disclosure will be described.

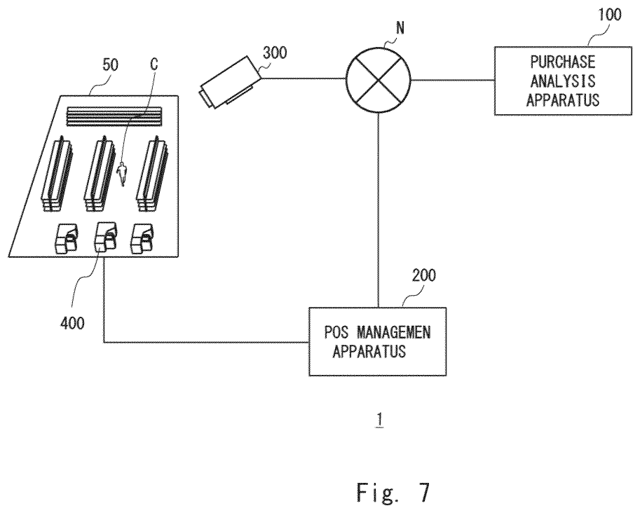

FIG. 7 is a diagram illustrating an overall configuration of a purchase analysis system 1 according to the fourth example embodiment. As an example, a general flow in a case where a customer C performs purchase behavior in a sales room 50 of a store is as follows.
(1) First, the customer C grasps a product from a product shelf in the sales room with a hand, and puts the product in a basket or moves in a direction away from the product shelf with the product.
(2) The customer C proceeds to another product shelf, grasps another product with a hand, and repeats an action of putting the product in the basket or holding the product and moving in a direction away from the product shelf.
(3) The customer C puts all the products desired to be purchased in the basket or takes the products and moves in a direction away from the product shelf, and proceeds to a cash register.
(4) The customer C completes performs accounting of all the products by the POS system.

Next, a description will be given of various examples in which the customer C performs non-purchase behavior not leading to final purchase in the sales room 50 of the store.
The customer C grasps a product from a product shelf, and then returns the product to the product shelf.
The customer C stops in front of a product shelf and keeps looking at a product for a certain period of time, but then moves to another place.
The customer C stops in front of a product shelf, extends a hand to a product, retracts the hand, and then moves to another place.
The customer C stops in front of a product shelf, grasps a plurality of products with hands, compares the products, puts only one in the basket, and returns the others to the product shelf.

Note that the above-described non-purchase actions are examples, and various non-purchase actions other than these non-purchase actions may be performed.

By using a point of sale (POS), a purchased product can be recognized and analyzed so far. However, various purchase actions including the non-purchase behavior described above cannot be analyzed.

The present disclosure relates to analyzing a product or the like by associating various purchase actions including non-purchase behavior with product-related information. As illustrated in FIG. 7, the purchase analysis system 1 is a computer system that monitors the customer C who visits the sales room 50 using one or more cameras 300, detects a predetermined action of the customer C, and analyzes a purchase action of a product and the customer in cooperation with the POS system. As used herein, non-purchase behavior or action refers to behavior or action of a customer who has not finally made a purchase or is highly likely not to make a purchase.

Here, the purchase analysis system 1 includes a purchase analysis apparatus (server) 100, a POS management apparatus 200, one or more cameras 300 in the sales room 50, and one or more POS terminal devices 400 in the sales room. The respective elements are connected to each other via a network N. The network N may be wired or wireless.

Even though only one camera 300 is illustrated in FIG. 7, a plurality of cameras 300 may be provided, and can be installed in various places of the sales room 50 to photograph the customer C and monitor the purchase action of the customer C. The camera 300 can be disposed at a position and an angle at which at least a part of a body of the customer C standing in front of the product shelf can be photographed. In addition, preferably, the camera 300 can be disposed at a position and an angle at which a relationship between the customer C standing in front of the product shelf and the product shelf can be recognized.

The purchase analysis apparatus 100 acquires video data in the sales room from the camera 300 via the network N. The purchase analysis apparatus 100 detects a purchase action related to product-related information of the sales room 50 performed by the customer C based on video data received from the camera 300. The product-related information may include a product in which the customer C is interested, a product shelf that can be associated with the product, or floor map information in the sales room. That is, the purchase analysis apparatus 100 can perform purchase analysis by obtaining information obtained by associating product-related information with an action of the customer in the sales room. In some example embodiments, a purchase action of the customer may be an action near a product shelf.

The POS management apparatus 200 collects sales data and the like for each product transmitted from the one or more POS terminal devices 400 (also referred to as POS cash registers) installed in the sales room 50 of the store, and can perform sales analysis or inventory management. Furthermore, in some example embodiments, the POS management apparatus 200 can cause the purchase analysis apparatus 100 to receive analysis information obtained by combining the purchase action of the customer C and the product-related information, and associate the analysis information with the sales data. The POS management apparatus 200 can receive the analysis information from the purchase analysis apparatus 100 and display the analysis information using a display unit 203. In another example embodiment, the purchase analysis apparatus 100 and the POS management apparatus 200 may be integrally configured. Furthermore, in still another example embodiment, the camera 300 and the purchase analysis apparatus 100 may be integrally configured.

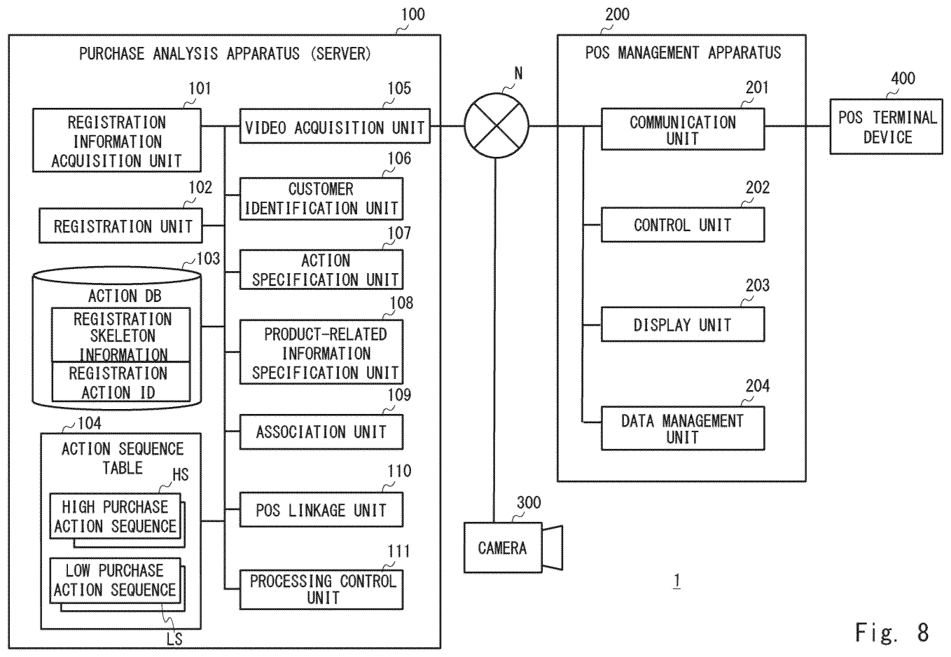

FIG. 8 is a block diagram illustrating detailed configurations of the purchase analysis apparatus 100 and the POS management apparatus 200 according to the third example embodiment.

### Purchase Analysis Apparatus 100

The purchase analysis apparatus 100 includes a registration information acquisition unit 101, a registration unit 102, an action DB 103, an action sequence table 104, a video acquisition unit 105, a customer identification unit 106, an action specification unit 107, a product-related information specification unit 108, an association unit 109, a POS linkage unit 110, and a processing control unit 111.

The registration information acquisition unit 101 is also referred to as a registration information acquisition means. The registration information acquisition unit 101 acquires a plurality of pieces of registration video data from the camera 300 or another camera by an operation of an administrator or the like of the purchase analysis apparatus 100. In the fourth example embodiment, each piece of registration video data is video data indicating a past individual action (for example, an action of taking out a product from a product shelf, an operation of putting a product in a basket, and the like) included in the purchase action of the customer in the sales room. The registration video data is reference data for specifying a purchase action of the customer in the video data acquired from the camera 300 at the time of operation. In the fourth example embodiment, the registration video data is a moving image including a plurality of frame images, but may be a still image (one frame image) in some example embodiments.

In addition, the registration information acquisition unit 101 acquires a plurality of registration action IDs and information about a time-series order in which an action is performed in a series of acts by an operation of the administrator and the like of the purchase analysis apparatus 100. The registration information acquisition unit 101 supplies the acquired information to the registration unit 102.

The registration unit 102 is also referred to as a registration means. First, the registration unit 102 executes action registration processing in response to an action registration request. Specifically, the registration unit 102 supplies the registration video data to the action specification unit 107 to be described later, and acquires skeleton information extracted from the registration video data from the action specification unit 107 as registration skeleton information. Then, the registration unit 102 registers the acquired registration skeleton information in the action DB 103 in association with the registration action ID. For example, the registration unit 102 can classify and register the extracted action pattern according to a purchase probability. For example, the registration unit 102 can classify and register an action pattern (HP) having a relatively high purchase probability and an action pattern (LP) having a relatively low purchase probability. In addition, in another example embodiment, the registration unit 102 can classify and register an action pattern (HP) having a relatively high purchase probability, an action pattern (MP) having a medium purchase probability, and an action pattern (LP) having a relatively low purchase probability. Note that these classifications are examples, and various modified examples are conceivable.

Next, the registration unit 102 executes sequence registration processing in response to the sequence registration request. Specifically, the registration unit 102 generates the registration action sequence by arranging the registration action IDs in time series based on the information about the time-series order. At this time, in a case where the sequence registration request is related to an action having a relatively high purchase probability, the registration unit 102 registers the generated registration action sequence in the action sequence table 104 as an action sequence HS having a relatively high purchase probability. Meanwhile, in a case where the sequence registration request is related to an action having a relatively low purchase probability, the registration unit 102 registers the generated registration action sequence in the action sequence table 104 as an action sequence LS having a relatively low purchase probability.

The action DB 103 is a storage apparatus that stores the registration skeleton information corresponding to each action included in the purchase behavior in association with the registration action ID. In addition, the action DB 103 may store registration skeleton information corresponding to each of actions included in action pattern (HP) having a relatively high purchase probability and the action pattern (LP) having a relatively low purchase probability in association with the registration action ID.

The action sequence table 104 stores the action sequence HS having a relatively high purchase probability and the action sequence LS having a relatively low purchase probability. In some example embodiments, the action sequence table 104 can store a plurality of action sequences HS having a relatively high purchase probability and a plurality of action sequences LS having a relatively low purchase probability. In addition, in some example embodiments, in addition to the action sequence HS and the action sequence LS, a plurality of action sequences MS having a medium purchase probability may be stored.

The video acquisition unit 105 is also referred to as an image acquisition means or a video acquisition means. The video acquisition unit 105 acquires video data captured by the plurality of cameras 300 during operation in the sales room 50. That is, the video acquisition unit 105 acquires the video data in response to detection of a start trigger. The video acquisition unit 105 supplies a frame image included in the acquired video data to the action specification unit 107. The start trigger may be, for example, when a customer enters a sales room or when a customer approaches a product shelf.

The customer identification unit 106 is also referred to as a customer identification means. The customer identification unit 106 determines the same customer by, for example, known face recognition technology or image recognition technology. As a result, as described later, a series of actions performed by the same customer can be specified. In addition, it is possible to determine whether or not the same customer has finally purchased a specific product.

Further, the customer identification unit 106 also functions as a position specification unit. The customer identification unit 106 specifies a position of the customer in the sales room (for example, a position where the customer is near a product shelf, a cash register, or the like). For example, since an angle of view of the camera is fixed to the sales room, a correspondence relationship between a position of the customer in a photographed image and a position of the customer in the sales room can be defined in advance, and the position in the image can be converted to the position in the sales room based on the definition. More specifically, in a first process, a height, an azimuth angle, and an elevation angle at which the camera that captures the image of the inside of the sales room is installed, and a focal length (hereinafter referred to as a camera parameter) of the camera are estimated from the captured image using an existing technology. These may be actually measured or a specification may be referred to. In a second process, the position where the foot of the person is located is converted from two-dimensional coordinates (hereinafter referred to as image coordinates) on the image to three-dimensional coordinates (hereinafter referred to as world coordinates) in the real world based on the camera parameters using the existing technology. The conversion from the image coordinates to the world coordinates is usually not uniquely determined, but the conversion can be uniquely performed by fixing the coordinate value in the height direction of the foot to zero, for example. In a third process, a map in the three-dimensional transportation means is prepared in advance, and the world coordinates obtained in the second process are projected onto the map, whereby the position of the customer in the sales room can be specified.

The action specification unit 107 is also referred to as an action specification means. The action specification unit 107 detects an image region (body region) of the body of the customer from the frame image included in the video data, and extracts the image region as a body image (for example, cutting out). Then, the action specification unit 107 extracts skeleton information of at least a part of the body of the customer based on features such as joints of the customer recognized in a body image using a skeleton estimation technique using machine learning. The skeletal information is information including a “key point” that is a characteristic point such as a joint and a “bone (bone link)” indicating a link between the key points. The action specification unit 107 may use, for example, a skeleton estimation technique such as OpenPose.

Further, the action specification unit 107 converts the skeleton information extracted from the video data acquired at the time of operation into the action ID using the action DB 103. As a result, the action specification unit 107 specifies various actions of the customer. Specifically, first, the action specification unit 107 specifies, from the registration skeleton information registered in the action DB 103, registration skeleton information having a similarity to the extracted skeleton information equal to or more than a predetermined threshold. Then, the action specification unit 107 specifies the registration action ID associated with the specified registration skeleton information as the action ID corresponding to the customer included in the acquired frame image.

Here, the action specification unit 107 may specify one action ID based on skeleton information corresponding to one frame image, or may specify one action ID based on time-series data of skeleton information corresponding to each of a plurality of frame images. When specifying one action ID using a plurality of frame images, the action specification unit 107 may extract only skeleton information having a large movement and collate the extracted skeleton information with registration skeleton information in the action DB 103. Extracting only skeleton information having a large movement may mean extracting skeleton information in which a difference between pieces of skeleton information of different frame images included within a predetermined period is a predetermined amount or more. Since such a small amount of collation is sufficient, the calculation load can be reduced, and the amount of registration skeleton information is also small. In addition, since only skeleton information having a large movement is used as the collation target although the duration of the action differs depending on the person, robustness can be given to action detection.

Note that, in addition to the above-described method, various methods can be considered for specifying the action ID. For example, there is a method of estimating the action ID from target video data using an action estimation model trained using video data correctly assigned by the action ID as learning data. However, it is difficult to collect the learning data, and the cost is high. Meanwhile, in the fourth example embodiment, the skeleton information is used for estimating the action ID, and is compared with the skeleton information registered in advance using the action DB 103. Therefore, in the fourth example embodiment, the purchase analysis apparatus 100 can more easily specify the action ID.

In the above-described similarity determination, the action specification unit 107 detects the unit action by calculating the similarity of the forms of the elements constituting the skeleton data. As an element of the skeleton data, a pseudo joint point or a skeleton structure for indicating a posture of the body is set. The form of the elements constituting the skeleton data can also be referred to as, for example, a relative geometric relationship of positions, distances, angles, and the like of other key points or bones when a certain key point or bone is used as a reference. Alternatively, the form of the elements constituting the skeleton data can also be, for example, one integrated form formed by a plurality of key points or bones.

The action specification unit 107 analyzes whether the relative forms of the elements are similar between two pieces of skeleton data to be compared. At this time, the action specification unit 107 calculates similarity between the two pieces of skeleton data. When calculating the similarity, the action specification unit 107 can calculate the similarity by, for example, a feature amount calculated from elements included in the skeleton data. The action specification unit 107 can also recognize a type of unit action by detecting a start action and an end action in the unit action.

The product-related information specification unit 108 is also referred to as a product-related information specification means. The product-related information specification unit 108 specifies the product-related information based on the position of the customer specified by the customer identification unit 106 or a predetermined action of the customer specified by the action specification unit 107. The product-related information is information associated with a specific product, and can include, for example, at least one or all of a product (for example, a product number, a product name, and the like), a product classification (for example, chocolate, confectionery, beverage, and the like), a product shelf, and floor map information. The product-related information specification unit 108 specifies the product-related information in which the customer is interested from the action of the customer. For example, when the customer holds a product with a hand, the product-related information specification unit 108 may recognize the product itself by a known image recognition technology or position information of the product in an angle of view of a camera, and specify the product itself. Furthermore, for example, when the customer is stopping in front of a product shelf on which a specific type of product is placed while directing a line of sight to a specific product, the product-related information specification unit 108 may specify the specific type of product, a product classification, or the product shelf. For example, the product-related information specification unit 108 may specify a product, a product shelf, or the like in which the customer is interested from the floor map information based on a position in the image at which the customer is present.

The association unit 109 is also referred to as an association means. The association unit 109 associates a purchase probability corresponding to a specified operation of the customer with product-related information specified based on the specified action of the customer. As a result, related information indicating a purchase probability related to product-related information can be obtained, and as a result, purchase analysis can be performed. Specifically, it is possible to perform classification into a product associated with an action having a relatively high purchase probability and a product associated with an action having a relatively low purchase probability. In particular, with respect to a product or a product classification, which has not been purchased or is not likely to be purchased, not obtained by the POS system so far, it is possible to obtain information indicating whether or not the customer is interested, and to perform more detailed purchase analysis.

The POS linkage unit 110 is also referred to as a POS linkage means. The POS linkage unit 110 cooperates with the POS terminal device 400 and the POS management apparatus 200 outside the purchase analysis apparatus 100 to support the above-described association. The POS linkage unit 110 can acquire sales information of a specified product based on the specified action for the identified customer. The POS linkage unit 110 can recognize whether or not a predetermined product specified based on a predetermined action specified by the action specification unit 107 has actually been purchased. Therefore, in cooperation with the POS linkage unit 110, the association unit 109 can obtain information indicating whether or not the customer is interested in a product that has not been purchased or what kind of action the customer is performing for the product, and can perform more detailed purchase analysis.

The processing control unit 111 is also referred to as a processing control means. The processing control unit 111 can output the above-described association information (that is, the analysis information) to the POS management apparatus 200 or the like and cause the display unit 203 of the POS management apparatus 200 to display the association information. In some example embodiments, the processing control unit 111 may display the above-described association information (that is, the analysis information) on a display unit (not illustrated) of the purchase analysis apparatus 100.

Note that, in a case of determining that the motion sequence does not correspond to any of the action sequences HS having high purchase probabilities, the association unit 109 may determine which of the action sequences LS having low purchase probabilities the motion sequence corresponds to. In this case, the processing control unit 111 may output, to the POS management apparatus 200, information determined in advance according to an action sequence having a low purchase probability or an action sequence having a high purchase probability. As an example, a display mode (font, color, or thickness of characters, blinking, or the like) may be changed according to a type of action sequence having a low purchase probability or action sequence having a high purchase probability. As a result, a store staff or a manager can recognize content of purchase behavior and analyze purchase of the customer in detail. In addition, the processing control unit 111 may record a time and a place at which the purchase action is performed and video as history information together with information of the type of action sequence having a low purchase probability or action sequence having a high purchase probability. As a result, a store staff or a manager can recognize content of purchase behavior and perform more detailed analysis.

### POS Management Apparatus 200

The POS management apparatus 200 includes a communication unit 201, a control unit 202, a display unit 203, and a data management unit 204.

The communication unit 201 is also referred to as a communication means. The communication unit 201 is a communication interface with the network N. Furthermore, the communication unit 201 is connected to the purchase analysis apparatus 100, and transmits the sales data to the purchase analysis apparatus 100 (POS linkage unit 110).

The control unit 202 is also referred to as a control means. The control unit 202 controls hardware included in the POS management apparatus 200. When the communication unit 201 receives the association information or the analysis information from the purchase analysis apparatus 100, the control unit 202 displays the association information or the analysis information on the display unit 203.

The display unit 203 is a display apparatus. The data management unit 204 manages sales data for each product aggregated by the POS system and the association or analysis information from the purchase analysis apparatus 100 as a history.

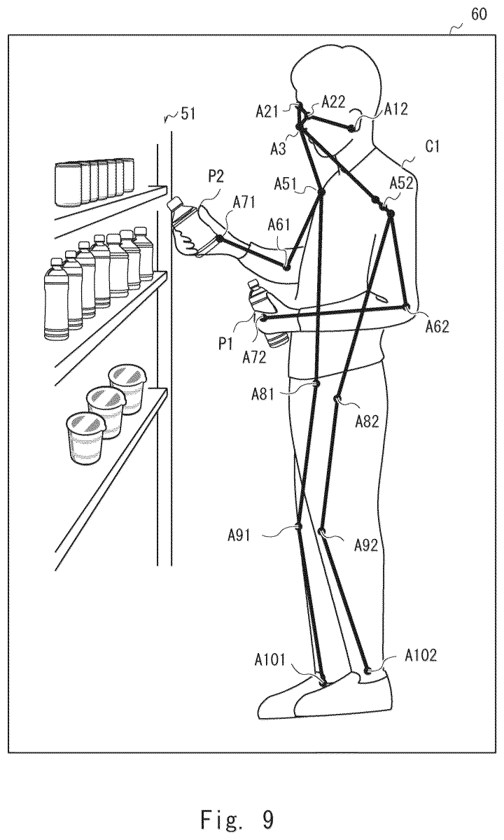

FIG. 9 is a diagram illustrating skeleton information of the customer extracted from a frame image 60 included in video data according to the fourth example embodiment. The frame image 60 is an image obtained by capturing, from the side, a customer C1 who performs an action of holding a product P1 with a left hand, holding a product P2 from a product shelf 51, and comparing the product P1 and the product P2. In addition, the skeleton information illustrated in FIG. 9 includes a plurality of key points and a plurality of bones detected from the entire body. As an example, in FIG. 9, a left ear A12, a right eye A21, a left eye A22, a nose A3, a right shoulder A51, a left shoulder A52, a right elbow A61, a left elbow A62, a right hand A71, a left hand A72, a right waist A81, a left waist A82, a right knee A91, a left knee A92, a right ankle A101, and a left ankle A102 are illustrated as key points.

The purchase analysis apparatus 100 compares such skeleton information of the customer with registration skeleton information corresponding to the entire body, and determines whether the skeleton information and the registration skeleton information are similar to each other, thereby specifying each action. For example, directions (lines of sight) of the right hand, the left hand, and the face are important in specifying the action of comparing two products. Further, as another example, in an action of “taking out a product from the basket” or “putting a product in the basket”, positions of the right hand and the left hand in the frame image are important.

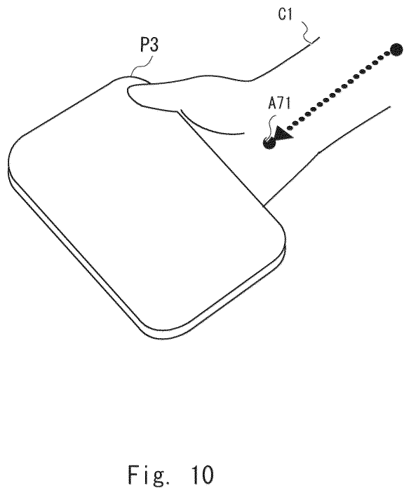

Note that the camera 300 may capture at least a hand region of the customer C1 from above. FIG. 10 is a partially enlarged view illustrating skeleton information extracted from the right hand of the frame image according to the fourth example embodiment. The partially enlarged view of the frame image illustrates a hand region of the customer C1 when the customer C1 performing an action of grasping a product P3 from a product shelf is photographed from above. As an example, FIG. 10 illustrates a right hand A71 as a key point. Then, the purchase analysis apparatus 100 may specify each action by comparing skeleton information extracted from a series of frame images with registered skeleton information corresponding to the hand region and determining whether or not these pieces of information are similar.

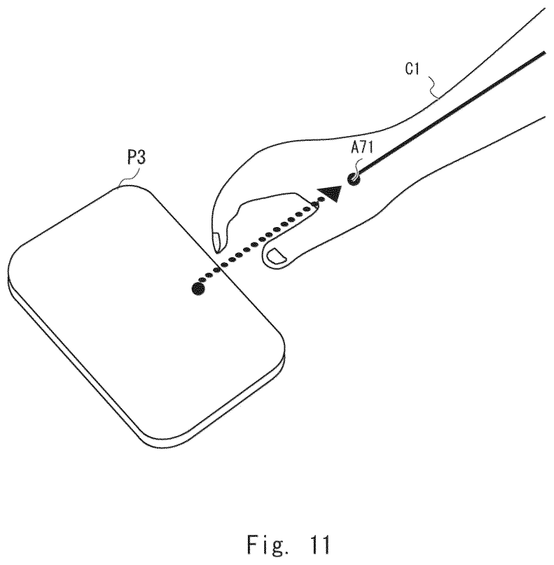

FIG. 11 is a partially enlarged view illustrating skeleton information extracted from the right hand of the frame image according to the fourth example embodiment. The partially enlarged view of the frame image illustrates a hand region of the customer C1 when the customer C1 performing an action of returning a product P3 to the product shelf and pulling the hand is photographed from an upper surface. As an example, FIG. 11 illustrates the right hand A71 as a key point. Then, the purchase analysis apparatus 100 may specify each action by comparing skeleton information extracted from a plurality of frame images (for example, the frame of FIG. 10 and the frame of FIG. 11) with registered skeleton information corresponding to the hand region and determining whether or not these pieces of information are similar. In this way, when an action of returning the product P3 to the product shelf and pulling a hand is specified, the purchase analysis apparatus 100 can determine that there is a high possibility that the customer C1 has not purchased the product P3. Furthermore, such an action pattern can be registered in advance in the action DB 103 as an action pattern (LP) having a relatively low purchase probability.

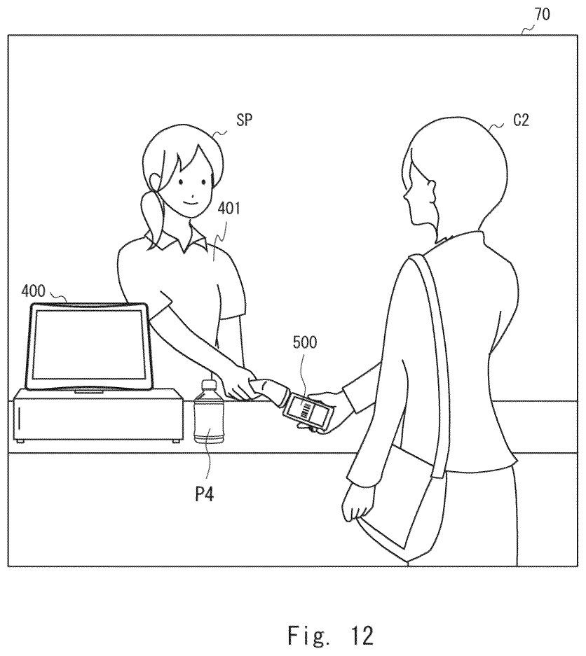

FIG. 12 illustrates a frame image 70 included in the video data according to the fourth example embodiment. Note that frame image 70 does not show skeleton information of a customer C2 for simplification. The frame image 70 illustrates a state in which the customer C2 performs accounting at the cash register to purchase a product P4. For example, the customer C2 uses a smartphone 500 of the customer to display electronic money (QR code (registered trademark)), and a store staff SP reads the electronic money displayed on a scanner 401, whereby accounting is performed. The POS terminal device 400 transmits sales data indicating purchase of the product P4 to the POS management apparatus 200 (FIG. 8). In this way, when an action of the customer performing accounting of the product P4 at the cash register is specified, the purchase analysis apparatus 100 can determine that the customer C2 has purchased (or is highly likely to have purchased) the product P4. Furthermore, such an action pattern can be registered in advance in the action DB 103 as an action pattern (HP) having a relatively high purchase probability.

Note that, as described above, the purchase analysis apparatus 100 may determine a purchase probability of a specific product from an action of the customer included in the plurality of frame images, but may determine whether or not the specific product has been reliably purchased from the sales data in cooperation with the POS management apparatus 200.

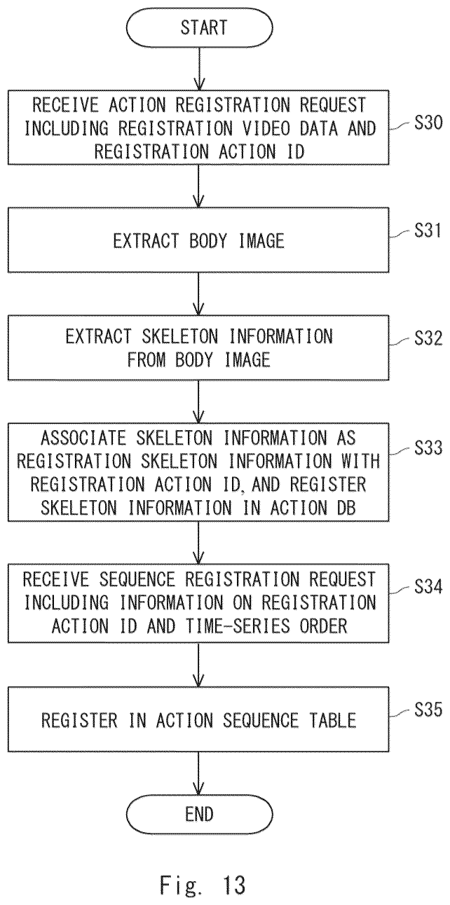

FIG. 13 is a flowchart illustrating a flow of a method of registering a registration action ID and a registration action sequence by the purchase analysis apparatus 100 according to the fourth example embodiment. First, the registration information acquisition unit 101 of the purchase analysis apparatus 100 receives an action registration request including registration video data and a registration action ID from a user interface (operation of the administrator) of the purchase analysis apparatus 100 (S30). Next, the registration unit 102 supplies the registration video data to the action specification unit 107. The action specification unit 107 acquiring the registration video data extracts a body image from a frame image included in the registration video data (S31). Next, the action specification unit 107 extracts skeletal information from the body image (S32). Next, the registration unit 102 acquires skeleton information from the action specification unit 107, and registers, in the action DB 103, the acquired skeleton information as registration skeleton information in association with the registration action ID (S33). Note that the registration unit 102 may set all pieces of skeleton information extracted from the body image as registration skeleton information, or may set only some pieces of skeleton information (for example, skeleton information of shoulder, elbow, and hand) as registration skeleton information. Next, the registration information acquisition unit 101 receives a sequence registration request including information on a plurality of registration action IDs and a time-series order of each action from the user interface (operation of the administrator) of the purchase analysis apparatus 100 (S34). Next, the registration unit 102 registers a registration action sequence (for example, the action sequence HS having a high purchase probability or the action sequence LS having a low purchase probability) in which registration action IDs are arranged based on the information on the time-series order in the action sequence table 104 (S35). Then, the purchase analysis apparatus 100 ends the processing.

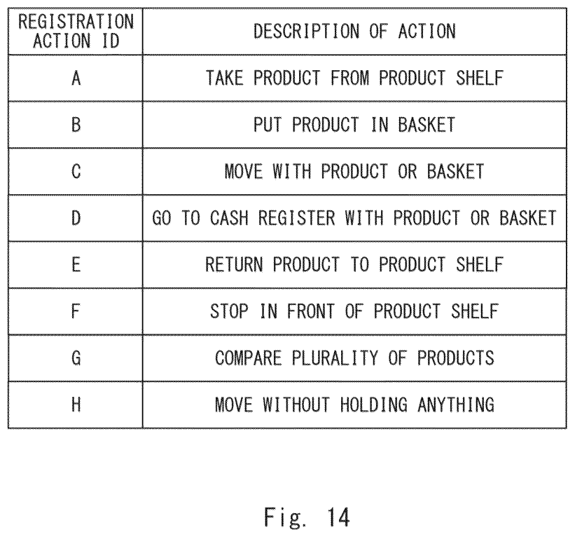

FIG. 14 is a diagram for describing the registration action according to the fourth example embodiment. As an example, registration skeleton information of eight registration actions having registration action IDs of “A” to “H” can be stored in the action DB 103. These registration actions are also referred to as unit actions. The registration action “A” is an action of taking out a product from a product shelf (see, for example, FIG. 9). The registration action “B” is an action of putting a product in a basket. The registration action “C” is an action of moving to another place (for example, another product shelf) with the product picked up from the product shelf or with the basket in which the product is put.

The registration action “D” is an action of moving to a cash register with the product itself or the basket (see, for example, FIG. 12). The registration action “E” is an action of returning the product to the product shelf (see, for example, FIG. 11). The registration action “F” is an action of stopping in front of the product shelf and looking at the product (see, for example, FIG. 9). The registration action “G” is an action of comparing a plurality of products (see, for example, FIG. 9). The registration action “H” is an action of moving from the product shelf to another place without holding anything.

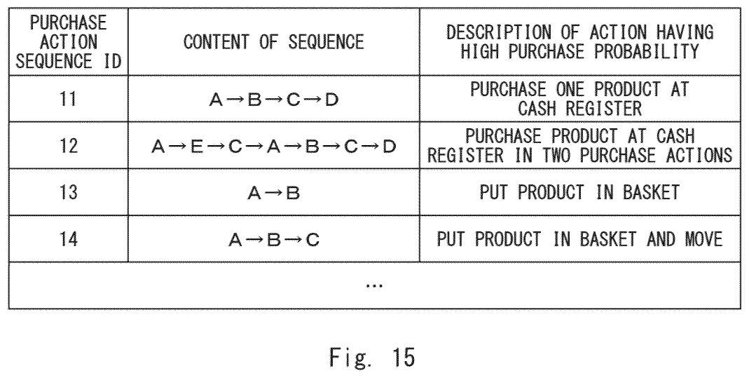

FIG. 15 is a diagram for explaining the action sequence HS having a high purchase probability according to the fourth example embodiment. The action sequence includes one or more unit actions. As an example, the action sequence table 104 may include at least four action sequences HS having high purchase probabilities having the purchase action sequence IDs of “11” to “14”. The action sequence “11” having a high purchase probability is a sequence (A→B→C→D) in which the customer purchases a product in one purchase action. The action sequence “12” having a high purchase probability is a sequence (A→E→C→A→B→C→D) in which the customer finally purchases a product in one non-purchase action and one purchase action. In this case, the specified non-purchase behavior is associated with the first product, and the specified purchase action is associated with the last product. The action sequence “13” having a high purchase probability is a sequence (A→B) in which the customer is likely to purchase a product in one purchase action. The action sequence “14” having a high purchase probability is a sequence (A→B→C) in which the customer is likely to purchase a product in one purchase action. As such, in some example embodiments, an action of putting a product in a basket (registration action “B”) and an action of moving to another place (for example, another product shelf) with the product picked up from the product shelf or with the basket containing the product (registration action “C”) may be determined to be an action sequence having a relatively high purchase probability.

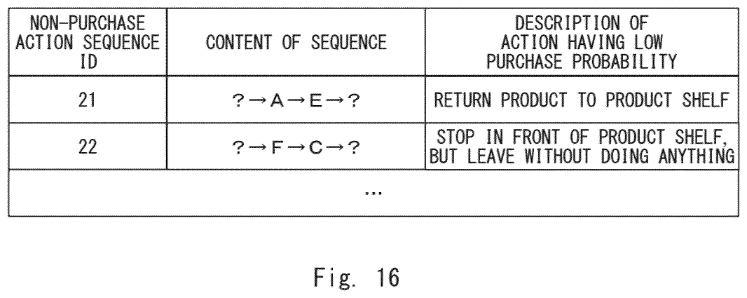

FIG. 16 is a diagram for explaining the action sequence LS having a low purchase probability according to the fourth example embodiment. The action sequence table 104 may include at least two action sequences LS having low purchase probabilities having action sequence IDs of “21” to “22”. The action sequence “21” having a low purchase probability is a sequence (?→A→E→?) including an action in which the customer picks up a product from a product shelf but returns the product to the product shelf. “?” indicates any action. Also in this case, the product and the action sequence can be associated with each other. Furthermore, the action sequence “22” having a low purchase probability is an action sequence (?→F→H→?) in which the customer stops in front of the product shelf but leaves without doing anything. Also in this case, the action sequence of the customer can be associated with the product shelf at the position where the customer stops.

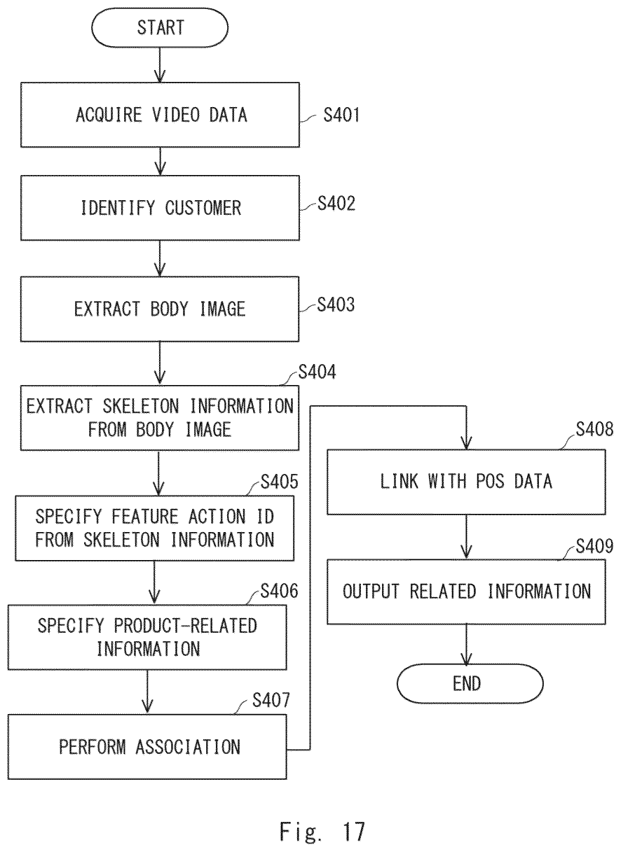

FIG. 17 is a flowchart illustrating a flow of a purchase analysis method by the purchase analysis apparatus 100 according to the fourth example embodiment. First, when the video acquisition unit 105 of the purchase analysis apparatus 100 acquires video data from the camera 300 (S401), the customer identification unit 106 identifies the customer by, for example, a known face recognition technology or image recognition technology (S402). For example, the customer identification unit 106 recognizes customer attribute information such as a height, clothes, a face, a hairstyle, a body shape, a sex, and an age group (for example, a person in his/her teens or younger, a person in his/her 20's to 50s, a person in his/her 60's or older, and the like.) of the customer, and stores the customer attribute information in the storage unit, thereby specifying that a series of actions is performed by the identified same person thereafter. For example, in the example of FIG. 9, the customer C1 can be identified as a man in his twenties with a medium height.

Thereafter, or in parallel therewith, the action specification unit 107 extracts a body image from a frame image included in the video data (S403). Next, the action specification unit 107 extracts the skeletal information from the body image (S404). The action specification unit 107 calculates a similarity between at least a part of the extracted skeleton information and each piece of registration skeleton information registered in the action DB 103, and specifies a registration action ID associated with registration skeleton information having a similarity equal to or more than a predetermined threshold as an action ID (S405). Next, in some example embodiments, the action specification unit 109 adds the action ID to the action sequence. Specifically, the action specification unit 107 sets the action ID specified in S405 as the action sequence in a first cycle, and adds the action ID specified in S405 to the already generated action sequence in the next and subsequent cycles.

The product-related information specification unit 108 specifies product-related information in which the customer is interested, based on the position of the customer specified by the customer identification unit (position specification unit) 106 and an action of the customer specified by the action specification unit 107 (S406). For example, when the customer holds a product with a hand, the product-related information specification unit 108 may recognize the product itself by a known image recognition technology, and specify the product itself. Furthermore, for example, when the customer is stopping in front of a product shelf on which a specific type of product is placed while directing a line of sight to the product shelf, the product-related information specification unit 108 may specify the specific type of product, a product classification, or the product shelf as the product-related information. For example, the product-related information specification unit 108 may specify a product, a product shelf, or the like in which the customer is interested from the floor map information based on a position in the image at which the customer specified by the customer identification unit (position specification unit) 106 is present.

The association unit 109 associates a purchase probability corresponding to a specified predetermined action with product-related information specified based on the predetermined action of the specified customer (S407). The association unit 109 may also associate these pieces of information with the customer attribute information described above. For example, in the example of FIG. 9, it is assumed that it is determined from a subsequent frame image that the customer C1 then returns the product P2 to the product shelf and moves with the product P1. In this case, the product P2 is associated with an action of a man in his twenties having a low purchase probability, and the product P1 is associated with an action of a man in his twenties having a high purchase probability. Such association information may be transmitted to the POS management apparatus 200. As a result, related information indicating a purchase probability related to product-related information can be obtained, and as a result, detailed purchase analysis can be performed. Specifically, it is possible to perform classification into a product associated with an action having a relatively high purchase probability and a product associated with an action having a relatively low purchase probability. In particular, with respect to a product or a product classification, which has not been purchased or is not likely to be purchased, not obtained by the POS system so far, it is possible to obtain information indicating whether or not the customer is interested, and to perform more detailed purchase analysis.

The POS linkage unit 110 cooperates with the POS terminal device 400 and the POS management apparatus 200 (S408) to support the above-described association. The POS linkage unit 110 can acquire sales information of a specified product based on the specified action for the identified customer. The POS linkage unit 110 can recognize whether or not a predetermined product specified based on an action of the customer specified by the action specification unit 107 has actually been purchased. Therefore, in cooperation with the POS linkage unit 110, the association unit 109 can obtain information indicating whether or not the customer is interested in a product that has not been purchased or what kind of action the customer is performing for the product, and can perform more detailed purchase analysis. It is possible to obtain information indicating what kind of purchase action the customer performs for the product finally purchased. For example, in the example of FIG. 9, it is assumed that it is determined from a subsequent frame image that the customer C1 then returns the product P2 to the product shelf and moves with the product P1. In this case, the product P2 is associated with an action of a man having a low purchase probability, and the product P1 is associated with an action of a man having a high purchase probability. However, when the sales are not recorded in the sales information for any of the products P1 and P2, the POS linkage unit 110 can associate, with each product, not only an action of returning the product P2 to the product shelf but also an action of moving with the product P1 as an action of not finally purchasing a product.

The processing control unit 111 can output the above-described association information (that is, the analysis information) to the POS management apparatus 200 or the like (S409) and cause the display unit 203 of the POS management apparatus 200 to display the association information.

As described above, according to the fourth example embodiment, the purchase analysis apparatus 100 determines a purchase probability of an action of the customer C for a specific product or the like by comparing an action sequence indicating a flow of the action of the customer C visiting the sales room 50 with the action pattern HP or the action sequence HS having a high purchase probability and the action pattern LP or the action sequence LS having a low purchase probability. In addition, by linking these pieces of related information with the sales information of the POS, it is possible to more accurately analyze an action of the customer C for a specific product or the like.

Although the flowchart of FIG. 17 illustrates a specific order of execution, the order of execution may be different from the depicted form. For example, the order of execution of two or more steps may be interchanged with respect to the indicated order. Also, two or more steps shown in succession in FIG. 17 may be performed simultaneously or partially simultaneously. Further, in some example embodiments, one or more steps illustrated in FIG. 17 may be skipped or omitted.

### Fifth Example Embodiment

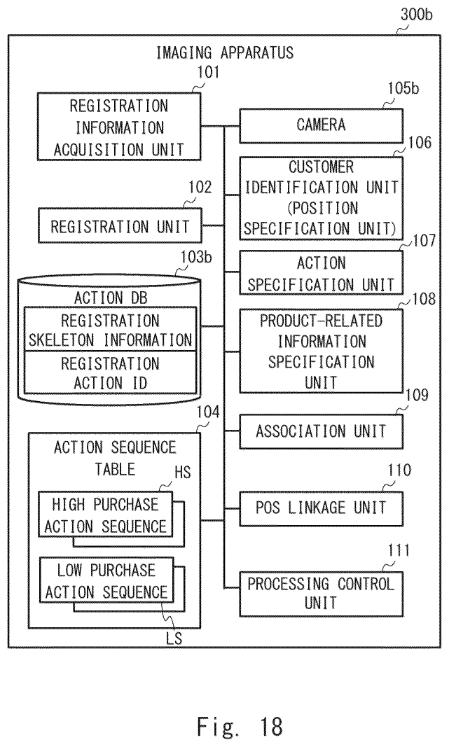

FIG. 18 is a block diagram illustrating a configuration of an imaging apparatus. The imaging apparatus 300b is also referred to as an intelligent camera, and may include a registration information acquisition unit 101, a registration unit 102, an action database 103, an action sequence table 104, a camera 105b, a customer identification unit 106, an action specification unit 107, a product-related information specification unit 108, an association unit 109, a POS linkage unit 110, and a processing control unit 111. Note that the configuration of the imaging apparatus 300b is basically similar to that of the purchase analysis apparatus 100 described above, and thus the description thereof is omitted, but the imaging apparatus is different in that the camera 105b is incorporated. The camera 105b includes, for example, an image sensor such as a complementary metal oxide semiconductor (CMOS) sensor or a charge coupled device (CCD) sensor. Further, the captured video data created by the camera 105b is stored in the action database 103b. The configuration of the imaging apparatus 300b is not limited thereto, and various modifications can be made.

Furthermore, in some example embodiments, the imaging apparatus 300b (intelligent camera) according to the fifth example embodiment and the purchase analysis apparatus 100 according to the fourth example embodiment may implement the object of the present disclosure by distributing some functions.

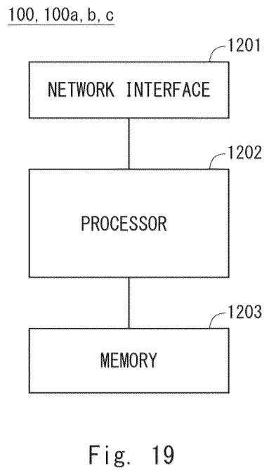

FIG. 19 is a block diagram illustrating a hardware configuration of the purchase analysis apparatus.

FIG. 19 is a block diagram illustrating a hardware configuration example of the purchase analysis apparatuses 100, 100a to c (hereinafter, the purchase analysis apparatus 100 and the like are used). Referring to FIG. 19, the purchase analysis apparatus 100 or the like includes a network interface 1201, a processor 1202, and a memory 1203. The network interface 1201 is used to communicate with other network node apparatuses that configure the communications system. The network interface 1201 may be used to perform wireless communication. For example, the network interface 1201 may be used to perform wireless LAN communication defined in IEEE 802.11 series or mobile communication defined in 3rd Generation Partnership Project (3GPP). Alternatively, the network interface 1201 may include, for example, a network interface card (NIC) in conformity with IEEE 802.3 series.

The processor 1202 performs a process of the purchase analysis apparatus 100 and the like described using the flowchart or sequence in the above-described example embodiments by reading and executing software (a computer program) from the memory 1203. The processor 1202 may be, for example, a microprocessor, a micro processing unit (MPU), or a central processing unit (CPU). The processor 1202 may include a plurality of processors.

The memory 1203 is configured in a combination of a volatile memory and a nonvolatile memory. The memory 1203 may include a storage disposed away from the processor 1202. In this case, the processor 1202 may access the memory 1203 through an I/O interface (not illustrated).

In the example of FIG. 19, the memory 1203 is used to store a software module group. The processor 1202 can perform the processing of the purchase analysis apparatus 100 or the like described in the above-described example embodiment by reading and executing these software module groups from the memory 1203.

As described with reference to the flowchart, each of the processors included in the purchase analysis apparatus 100 and the like executes one or a plurality of programs including a command group causing a computer to perform the algorithm described with reference to the drawings.

In the above-described example embodiment, the configuration of the hardware has been described, but the present disclosure is not limited thereto. The present disclosure can also be implemented by causing a processor to execute a computer program.

In the above-described example, the program includes a group of instructions (or software code) for causing a computer to perform one or more functions described in the example embodiments when being read by the computer. The program may be stored in a non-transitory computer-readable medium or a tangible storage medium. By way of example, and not limitation, computer-readable media or tangible storage media include random-access memory (RAM), read-only memory (ROM), flash memory, solid-state drive (SSD) or other memory technology, CD-ROM, digital versatile disc (DVD), Blu-ray® disc or other optical disk storage, magnetic cassettes, magnetic tape, magnetic disk storage, or other magnetic storage devices. The program may be transmitted on a transitory computer-readable medium or a communication medium. As an example and not by way of limitation, the transitory computer-readable medium or the communication medium includes electrical, optical, acoustic, or other forms of propagated signals.

Some or all of the above-described example embodiments can be described as in the following Supplementary Notes, but are not limited to the following Supplementary Notes.

### Supplementary Note 1

A purchase analysis apparatus including
an action specification means for analyzing an action of a customer in a sales room included in captured video data and specifying the action of the customer according to a stored action pattern,
a product-related information specification means for specifying product-related information in which the customer is interested, based on the specified action of the customer or a position of the customer, and
an association means for associating the specified action with the product-related information.

### Supplementary Note 2

The purchase analysis apparatus according to Supplementary Note 1, wherein the specified action includes various actions of the customer performed near a product shelf in the sales room.

### Supplementary Note 3

The purchase analysis apparatus according to Supplementary Note 1 or 2, wherein the stored action pattern is an action associated with the product-related information, and includes at least an action pattern having a relatively high purchase probability and an action pattern having a relatively low purchase probability.

### Supplementary Note 4

The purchase analysis apparatus according to any one of Supplementary Notes 1 to 3, further including a storage unit configured to store at least an action pattern having a relatively low purchase probability based on a plurality of consecutive image frames, wherein
the action specification means specifies an action of the customer having a relatively low purchase probability based on the stored action pattern having the relatively low purchase probability, and
the association means associates the specified action having the relatively low purchase probability with the specified product-related information.

### Supplementary Note 5

The purchase analysis apparatus according to any one of Supplementary Notes 1 to 4, further including a POS linkage means for acquiring, from a POS management apparatus, sales information of a product or product-related information specified based on the specified action, wherein
when there is the sales information for the specified product or product-related information, the association means associates the specified action with the product or product-related information, and
when there is no sales information for the specified product or product-related information, the association means associates the specified action with the product or product-related information.

### Supplementary Note 6

The purchase analysis apparatus according to Supplementary Note 3, wherein the action pattern having the relatively low purchase probability is an action of the customer returning a product to a product shelf.

### Supplementary Note 7

The purchase analysis apparatus according to any one of Supplementary Notes 1 to 6, wherein the specified action includes an action of the customer grasping a product.

### Supplementary Note 8

The purchase analysis apparatus according to any one of Supplementary Notes 1 to 7, wherein the specified action includes an action of the customer comparing a plurality of products.

### Supplementary Note 9

The purchase analysis apparatus according to any one of Supplementary Notes 1 to 8, wherein the specified action includes an action of the customer stopping in front of a product or a product shelf for a predetermined period or more.

### Supplementary Note 10

The purchase analysis apparatus according to any one of Supplementary Notes 1 to 9, further including a customer identification means for identifying the customer,
wherein the association means groups and associates a series of actions performed by the identified customer.

### Supplementary Note 11

The purchase analysis apparatus according to Supplementary Note 10, wherein
the customer identification means specifies a position of the customer, and
the product-related information specification means specifies product-related information based on the specified position of the customer.

### Supplementary Note 12

The purchase analysis apparatus according to any one of Supplementary Notes 1 to 10, wherein the product-related information includes at least one of a product, a product classification, a product shelf, and floor map information.

### Supplementary Note 13

The purchase analysis apparatus according to any one of Supplementary Notes 1 to 11, in which the action specification means specifies a feature point and a pseudo skeleton of a body of the customer based on video data.

### Supplementary Note 14

A purchase analysis method including
analyzing an action of a customer in a sales room included in captured video data and specifying the action of the customer according to a stored action pattern,
specifying product-related information in which the customer is interested, based on the specified action of the customer or a position of the customer, and
associating the specified action with the product-related information.

### Supplementary Note 15

A non-transitory computer-readable medium storing a program for causing a computer to execute a purchase analysis method, the purchase analysis method including
analyzing an action of a customer in a sales room included in captured video data and specifying the action of the customer according to a stored action pattern,
specifying product-related information in which the customer is interested, based on the specified action of the customer or a position of the customer, and
associating the specified action with the product-related information.

### REFERENCE SIGNS LIST

1 PURCHASE ANALYSIS SYSTEM
50 SALES ROOM
51 PRODUCT SHELF
60 FRAME IMAGE
70 FRAME IMAGE
100, 100a, 100b, 100c PURCHASE ANALYSIS APPARATUS (SERVER)
101 REGISTRATION INFORMATION ACQUISITION UNIT
102 REGISTRATION UNIT
103 ACTION DB
103b, 103c STORAGE UNIT
104 ACTION SEQUENCE TABLE
105 VIDEO ACQUISITION UNIT
106 CUSTOMER IDENTIFICATION UNIT (POSITION SPECIFICATION UNIT)
107, 107a, 107b, 107c ACTION SPECIFICATION UNIT
108, 108a, 108b, 108c PRODUCT-RELATED INFORMATION SPECIFICATION UNIT
109, 109a, 109b, 109c ASSOCIATION UNIT
110, 110c POS LINKAGE UNIT
111 PROCESSING CONTROL UNIT
200, 200a POS MANAGEMENT APPARATUS
201 COMMUNICATION UNIT
202 CONTROL UNIT
203 DISPLAY UNIT
204 DATA MANAGEMENT UNIT
300 CAMERA
300b IMAGING APPARATUS
400 POS TERMINAL DEVICE
401 SCANNER
500 SMARTPHONE
C CUSTOMER
N NETWORK

What is claimed is:

1. A purchase analysis apparatus comprising:
at least one memory storing instructions, and
at least one processor configured to execute the instructions to;
analyze an action of a customer in a sales room included in captured video data;
specify the action of the customer according to a stored action pattern;
specify product-related information in which the customer is interested, based on the specified action of the customer or a position of the customer; and
associate the specified action with the product-related information.

2. The purchase analysis apparatus according to claim 1, wherein the specified action includes various actions of the customer performed near a product shelf in the sales room.

3. The purchase analysis apparatus according to claim 1, wherein the stored action pattern is an action associated with the product-related information, and includes at least an action pattern having a relatively high purchase probability and an action pattern having a relatively low purchase probability.

4. The purchase analysis apparatus according to claim 1, wherein
the at least one processor is configured to execute the instructions to:
store at least an action pattern having a relatively low purchase probability based on a plurality of consecutive image frames;
specify an action of the customer having a relatively low purchase probability based on the stored action pattern having the relatively low purchase probability; and
associate the specified action having the relatively low purchase probability with the specified product-related information.

5. The purchase analysis apparatus according to claim 1,
wherein the at least one processor is configured to execute the instructions to acquire, from a POS management apparatus, sales information of a product or product-related information specified based on the specified action, wherein
when there is the sales information for the specified product or product-related information, the at least one processor is configured to execute the instructions to associate the specified action with the product or product-related information, and
when there is no sales information for the specified product or product-related information, the at least one processor is configured to execute the instructions to associate the specified action with the product or product-related information.

6. The purchase analysis apparatus according to claim 3, wherein the action pattern having the relatively low purchase probability is an action of the customer returning a product to a product shelf.

7. The purchase analysis apparatus according to claim 1, wherein the specified action includes an action of the customer grasping a product.

8. The purchase analysis apparatus according to claim 1, wherein the specified action includes an action of the customer comparing a plurality of products.

9. The purchase analysis apparatus according to claim 1, wherein the specified action includes an action of the customer stopping in front of a product or a product shelf for a predetermined period or more.

10. The purchase analysis apparatus according to claim 1,
wherein the at least one processor is configured to execute the instructions to identify the customer; and
group and associate a series of actions performed by the identified customer.

11. The purchase analysis apparatus according to claim 10, wherein
the at least one processor is configured to execute the instructions to specify a position of the customer; and
specify product-related information based on the specified position of the customer.

12. The purchase analysis apparatus according to claim 1, wherein the product-related information includes at least one of a product, a product classification, a product shelf, and floor map information.

13. The purchase analysis apparatus according to claim 1, wherein the at least one processor is configured to execute the instructions to specify a feature point and a pseudo skeleton of a body of the customer based on video data.

14. A purchase analysis method comprising:
analyzing an action of a customer in a sales room included in captured video data;
specifying the action of the customer according to a stored action pattern;
specifying product-related information in which the customer is interested, based on the specified action of the customer or a position of the customer; and
associating the specified action with the product-related information.

15. A non-transitory computer-readable medium storing a program for causing a computer to execute a purchase analysis method, the purchase analysis method comprising:
analyzing an action of a customer in a sales room included in captured video data;
specifying the action of the customer according to a stored action pattern;
specifying product-related information in which the customer is interested, based on the specified action of the customer or a position of the customer; and
associating the specified action with the product-related information.
